(19) United States
(12) Patent Application Publication
(10) Pub. No.: US 2019/0116298 A1
(43) Pub. Date: Apr. 18, 2019

(54) CAMERA MODULE FOR VEHICLE

(71) Applicant: Primax Electronics Ltd., Neihu (TW)

(72) Inventor: Yi-Ching TSAI, Neihu (TW)

(21) Appl. No.: 15/909,268

(22) Filed: Mar. 1, 2018

(30) Foreign Application Priority Data
Oct. 13, 2017 (TW) 106135144

(51) Int. Cl. H04N 5/225; H04N 5/232; G03B 17/08; B60R 11/04

(52) U.S. Cl. CPC H04N 5/2252; B60R 11/04; G03B 17/08; H04N 5/23248

(57) ABSTRACT

The present invention provides a camera module for a vehicle, including a protection housing, a shooting module, and a control circuit module. The shooting module and the control circuit module are located in the protection housing. The protection housing has a hollow sleeve, and the hollow sleeve is in communication with an internal space and an external space of the protection housing. The control circuit module includes a connection end circuit board and an electrical connector. One end of the electrical connector is connected to and disposed on the connection end circuit board, and the other end of the electrical connector runs through the hollow sleeve, so as to be engaged with an electronic element.

### FIELD OF THE INVENTION

A main objective of the present invention is to provide a camera module for a vehicle, and in particular, a camera module for a vehicle having waterproof performance.

### BACKGROUND OF THE INVENTION

Currently, with the development of science and technology, the vehicle industry gradually enters the field of automated driving. A camera module for a vehicle is the most important electronic element for automated driving, and is used to replace eyes of humans during driving and then achieve a function of learning a road condition by means of calculation by a back-end computer.

However, because the camera module for a vehicle is disposed on the vehicle, a shockproof coefficient of the camera module needs to be particularly considered. The reason is that the vehicle is usually driven on a bumpy road, and therefore the camera module is frequently vibrated up and down in a short time, and for a long time, various electronic components in the camera module for a vehicle crash with each other to be disintegrated and detached. Further, during manufacturing of each of the electronic components in the camera module for a vehicle, a tolerance inevitably exists. Consequently, there is usually a problem that the electronic components cannot be accurately aligned for assembly when the electronic components are assembled with each other.

Further, the vehicle is usually caught in the rain when being driven out. The camera module is a precise electronic element that cannot be damped, and rainwater can easily leak into an inner space in a housing body through seams between the housing body of the camera module for a vehicle and other elements (for example, a connector plastic member). As a result, the electronic components are damaged, and complete waterproofing cannot be achieved even if a waterproof rubber ring is added at the seam. Therefore, a waterproof function of a conventional camera module for a vehicle still needs to be improved.

### SUMMARY OF THE INVENTION

A main objective of the present invention is to provide a camera module for a vehicle, so as to achieve an objective of preventing water from leaking from a protection housing and a hollow sleeve by growing the hollow sleeve at the protection housing.

A preferred implementation concept of the present invention is to provide a camera module for a vehicle, including:

a protection housing, including a front housing body and a rear housing body, where the front housing body and the rear housing body are assembled with each other to define an accommodation space; the rear housing body has a hollow sleeve; and the hollow sleeve protrudes and extends backward from a rear surface of the rear housing body, so that the hollow sleeve is in communication with the accommodation space to an external space;

a shooting module, accommodated in the accommodation space, and including a lens element, a photosensitive element, and a shooting end circuit board, where the photosensitive element is disposed on the shooting end circuit board; and the lens element extends out of the front housing body and is disposed in front of the photosensitive element;

a control circuit module, disposed between the shooting module and the rear housing body, and including a connection end circuit board and an electrical connector, where one end of the electrical connector is connected to and disposed on the connection end circuit board; and the other end of the electrical connector runs through the hollow sleeve; and

a flexible flat cable, accommodated in the accommodation space, where two ends of the flexible flat cable are respectively connected to the connection end circuit board and the shooting end circuit board, so that the shooting module is electrically connected to the control circuit module.

In a preferred embodiment, the electrical connector has a terminal portion and a male connector portion; the electrical connector is electrically connected to the connection end circuit board by using the terminal portion; and the male connector portion is a free end, so as to be engaged with an external female connector portion.

In a preferred embodiment, the connection end circuit board has a plurality of electrical jacks; the terminal portion has a plurality of electrical pins; and the electrical pins of the terminal portion are correspondingly inserted into the electrical jacks.

In a preferred embodiment, the hollow sleeve has an inner hook structure that is formed at an inner side surface of the hollow sleeve; the male connector portion has a fastening bulge ring that is formed at a side surface of the male connector portion; and the male connector portion runs through the hollow sleeve, so that the fastening bulge ring of the male connector portion is fastened with the inner hook structure of the hollow sleeve.

In a preferred embodiment, the inner hook structure is surrounded by a plurality of projections that flush with each other.

In a preferred embodiment, the electrical connector is a Fakra electrical connector.

In a preferred embodiment, the flexible flat cable is connected to the connection end circuit board and the shooting end circuit board by means of welding, or the flexible flat cable is connected to the connection end circuit board and the shooting end circuit board by means of adhesion.

In a preferred embodiment, the hollow sleeve has an outer hook structure; the outer hook structure is formed by means of protruding outward from an outer side surface of the hollow sleeve; and the outer hook structure is used to be engaged with an external hook member.

### BRIEF DESCRIPTION OF THE DRAWINGS

FIG. 1 is a schematic three-dimensional diagram of a camera module for a vehicle at an angle according to the present invention;

FIG. 2 is a schematic three-dimensional diagram of a camera module for a vehicle at another angle according to the present invention;

FIG. 3 is a schematic exploded view of a camera module for a vehicle at an angle according to the present invention;

FIG. 4 is a schematic exploded view of a camera module for a vehicle at another angle according to the present invention; and

FIG. 5 is a schematic cross-sectional view of a camera module for a vehicle according to the present invention.

### DETAILED DESCRIPTION OF THE PREFERRED EMBODIMENT

With the development of the vehicle industry, many vehicle factories together launch some standard components dedicated to vehicles, such as a Fakra electrical connector. The standard components have at most 40 electrical pins, and are compatible with an old vehicle connection specification ISO 10487. An electrical connector described below in the present invention includes, but is not limited to, a Fakra electrical connector, and this is stated first herein.

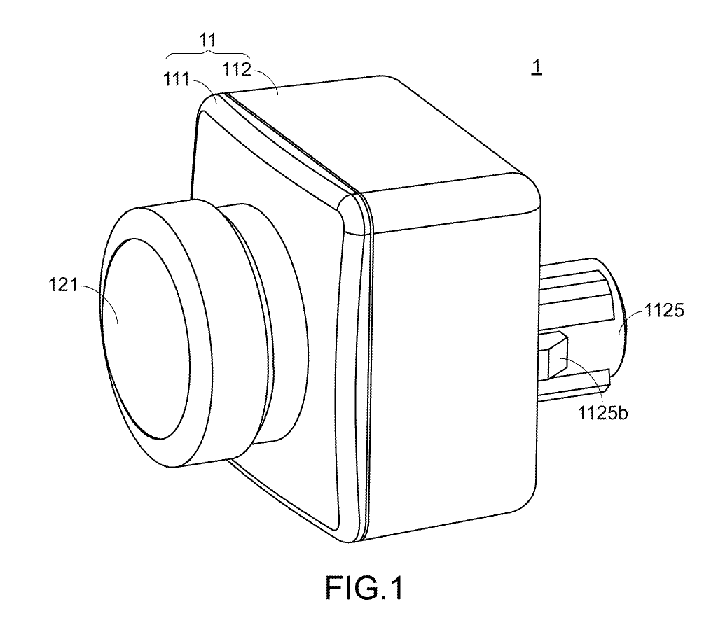

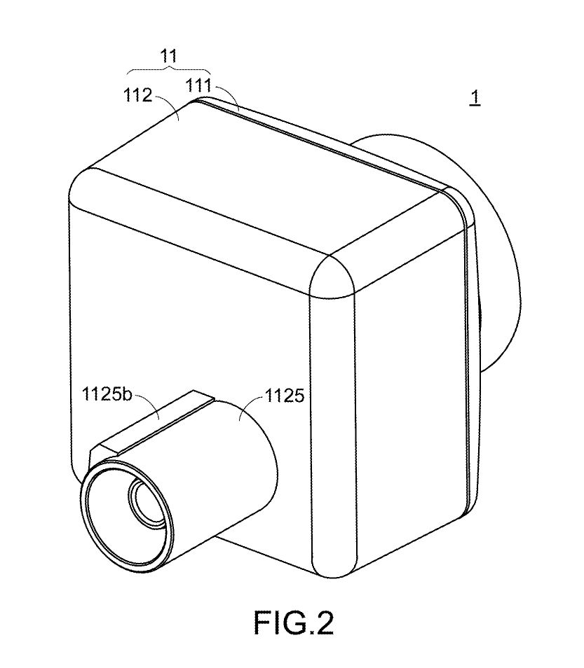

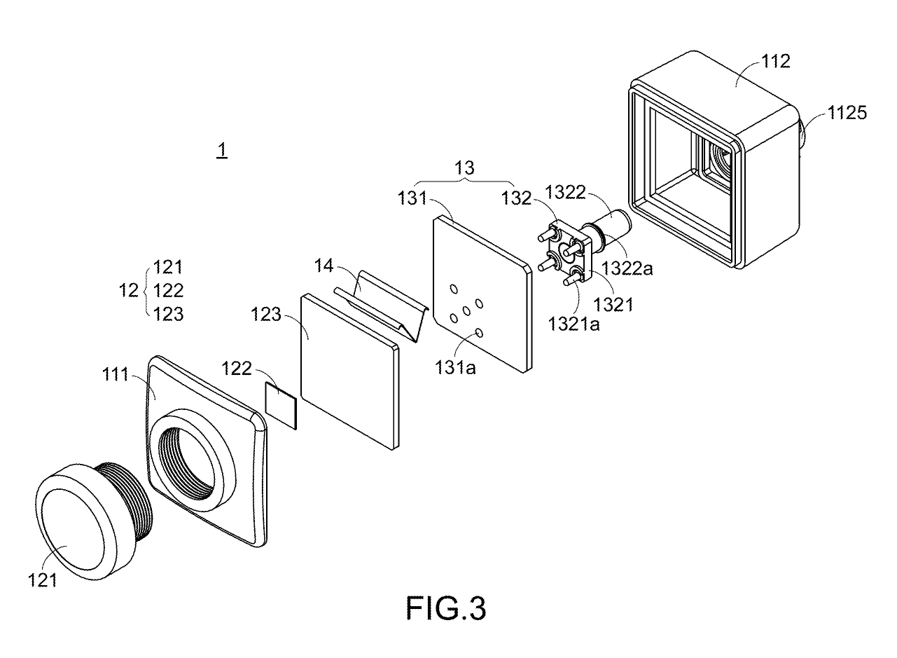

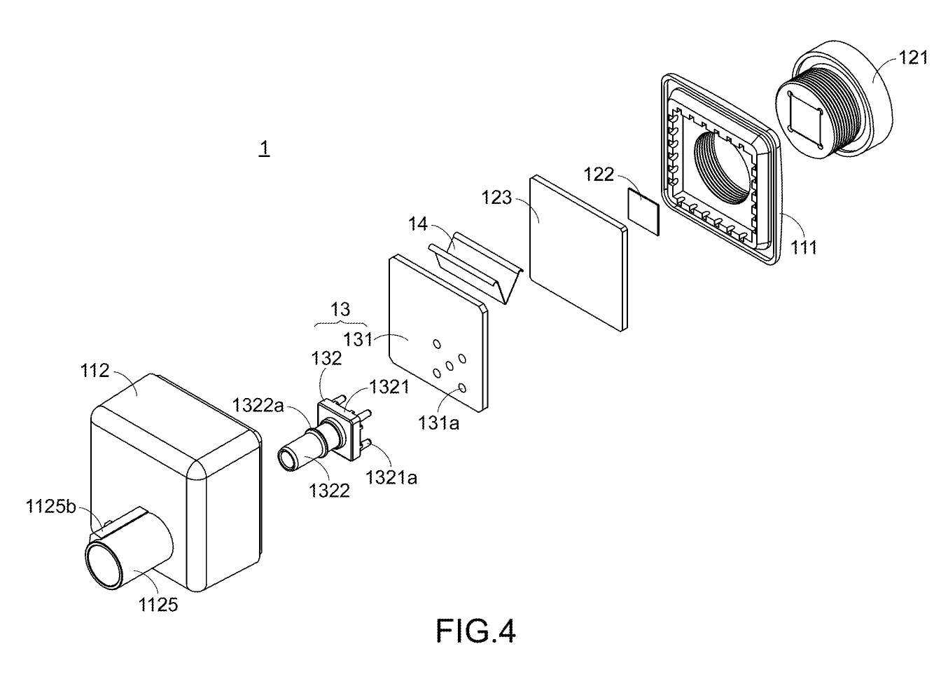

Referring to FIG. 1 to FIG. 4, FIG. 1 is a schematic three-dimensional diagram of a camera module for a vehicle according to the present invention; FIG. 2 is a schematic three-dimensional diagram of a camera module for a vehicle at another angle according to the present invention; FIG. 3 is a schematic exploded view of a camera module for a vehicle at an angle according to the present invention; and FIG. 4 is a schematic exploded view of a camera module for a vehicle at another angle according to the present invention. A camera module 1 for a vehicle in the present invention includes a protection housing 11, a shooting module 12, a control circuit module 13, and a flexible flat cable 14. The protection housing 11 includes a front housing body 111 and a rear housing body 112. The front housing body 111 and the rear housing body 112 are assembled with each other to define an accommodation space 110. Moreover, both the control circuit module 13 and the flexible flat cable 14 are located in the accommodation space 110 in the protection housing 11. In FIG. 1, the shooting module 12 extends out of the front housing body 111, so that a lens element 121 of the shooting module 12 is exposed, so as to receive light from an external environment and record an environment image.

Further, the rear housing body 112 has a hollow sleeve 1125. The hollow sleeve 1125 protrudes and extends backward from a rear surface of the rear housing body 112. The hollow sleeve 1125 is hollow to make the accommodation space 110 be in communication with an external space, so that an electrical connector 132 located in the protection housing 11 is disposed to penetrate the hollow sleeve 1125 and is connected to the exterior. In addition, the hollow sleeve 1125 is formed by means of directly protruding outward from the rear surface of the rear housing body 112. That is, the rear housing body 112 is an integrally formed structure, and therefore has an advantage of preventing a liquid from leaking into the accommodation space 110 in the rear housing body 112.

Refer to FIG. 3 and FIG. 4 again. It can be learned from the schematic exploded views that the shooting module 12 includes a lens element 121, a photosensitive element 122, and a shooting end circuit board 123. The lens element 121 is disposed in front of the photosensitive element 122, and the shooting end circuit board 123 is disposed behind the photosensitive element 122. Preferably, the photosensitive element 122 is mounted on the shooting end circuit board 123. By means of this setting, the light from the external environment enters, from the front, the protection housing 11 after passing through the lens element 121, and then is irradiated on the photosensitive element 122.

In addition, for the entirety, a camera manufacturer provides only a part of the shooting module 12. However, an additional circuit component is required to be connected to a host of a vehicle when the shooting module 12 is applied to the vehicle. The control circuit module 13 in the present invention is being responsible for signal connection with the host of the vehicle, so as to control and transmit a signal. The control circuit module 13 is located between the shooting module 12 and the rear housing body 112. Specifically, the control circuit module 13 includes a connection end circuit board 131 and an electrical connector 132. The electrical connector 132 may be a Fakra electrical connector as described above. One end of the Fakra electrical connector is connected to and disposed on the connection end circuit board 131. Preferably, one end of the Fakra electrical connector is backward welded or bonded to the connection end circuit board 131, and the other end of the Fakra electrical connector runs through the hollow sleeve 1125.

Further, to avoid a disadvantage that a hardware component in a conventional camera module for a vehicle may be disintegrated and detached because of vibrations after the conventional camera module for a vehicle is used for long, the flexible flat cable 14 is particularly selected in the present invention. The flexible flat cable 14 is flexible, and therefore may be disposed between the connection end circuit board 131 and the shooting end circuit board 123, so as to resolve a problem that there is a tolerance during assembly. Preferably, by means of welding or adhesion, two ends of the flexible flat cable 14 may be respectively fixedly connected to the connection end circuit board 131 and the shooting end circuit board 123, so that the shooting module 12 is electrically connected to the control circuit module 13. Preferably, by means of the connection manner that may be welding or adhesion, vibrations are absorbed and reliability is improved. In this way, problems of poor electrical contact or electrical detachment between the connection end circuit board 131 and the shooting end circuit board 123 due to vibrations generated during driving of the vehicle are avoided.

Subsequently, the electrical connector 132 is further described. The electrical connector 132 has a terminal portion 1321 and a male connector portion 1322. The electrical connector 132 is electrically connected to the connection end circuit board 131 by using the terminal portion 1321. The male connector portion 1322 is a free end, and is used to be engaged with an external female connector portion. In a preferred embodiment, the connection end circuit board 131 has a plurality of electrical jacks 131a, and the terminal portion 1321 has a plurality of electrical pins 1321a. The plurality of electrical pins of the terminal portion 1321 is correspondingly inserted into the plurality of electrical jacks 131a, and then is welded, so as to improve connection stability of the structure.

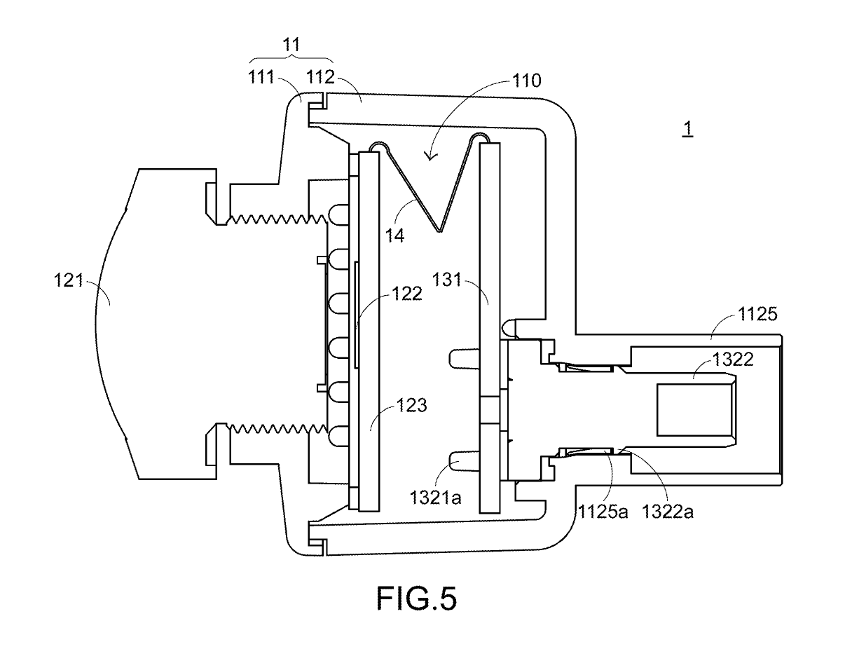

FIG. 5 is a schematic cross-sectional view of a camera module for a vehicle according to the present invention, and refer to FIG. 3 to FIG. 5. Specifically, the male connector portion 1322 has a fastening bulge ring 1322a that is formed at a side surface of the male connector portion 1322. The hollow sleeve 1125 has an inner hook structure 1125a that is formed at an inner side surface of the hollow sleeve 1125. The male connector portion 1322 runs through the hollow sleeve 1125, so that the fastening bulge ring 1322a of the male connector portion 1322 is fastened with the inner hook structure 1125a of the hollow sleeve 1125, thereby implementing the functions of fixing and positioning. The inner hook structure 1125a of the hollow sleeve 1125 is surrounded by a plurality of projections that flush with each other. The fastening bulge ring 1322a may be fastened with the inner hook structure 1125a after sliding to contact the projections.

In addition, the hollow sleeve 1125 has an outer hook structure 1125b. The outer hook structure 1125b is formed by means of protruding outward from an outer side surface of the hollow sleeve 1125. The outer hook structure 1125b is used to be engaged with another external hook member.

In view of the above, in the camera module for a vehicle in the present invention, an external liquid can be prevented from leaking into a gap between the rear housing body and the hollow sleeve by growing the hollow sleeve at the integrally formed rear housing body. Further, the two ends of the flexible flat cable are welded with and fixed to the connection end circuit board and the shooting end circuit board. In this way, electrical connection can be implemented, and vibrations generated during driving of the vehicle can be further absorbed, so as to avoid a problem of poor electrical contact because various electronic components crash with each other.

The foregoing embodiments are merely examples for describing the principle and effects of the present invention and for explaining the technical features of the present invention, but are not intended to limit the protection scope of the present invention. Modifications or equivalent arrangements that can be easily made by a person skilled in the art without departing from the technical principle and spirit of the present invention shall fall within the scope of the present invention. Therefore, the protection scope of the present invention is subject to the appended claims.

What is claimed is:

1. A camera module for a vehicle, comprising:
a protection housing, comprising a front housing body and a rear housing body, wherein the front housing body and the rear housing body are assembled with each other to define an accommodation space; the rear housing body has a hollow sleeve; and the hollow sleeve protrudes and extends backward from a rear surface of the rear housing body, so that the hollow sleeve is in communication with the accommodation space to an external space;
a shooting module, accommodated in the accommodation space, and comprising a lens element, a photosensitive element, and a shooting end circuit board, wherein the photosensitive element is disposed on the shooting end circuit board; and the lens element extends out of the front housing body and is disposed in front of the photosensitive element;
a control circuit module, disposed between the shooting module and the rear housing body, and comprising a connection end circuit board and an electrical connector, wherein one end of the electrical connector is connected to and disposed on the connection end circuit board; and the other end of the electrical connector runs through the hollow sleeve; and
a flexible flat cable, accommodated in the accommodation space, wherein two ends of the flexible flat cable are respectively connected to the connection end circuit board and the shooting end circuit board, so that the shooting module is electrically connected to the control circuit module.

2. The camera module for a vehicle according to claim 1, wherein the electrical connector has a terminal portion and a male connector portion; the electrical connector is electrically connected to the connection end circuit board by using the terminal portion; and the male connector portion is a free end, so as to be engaged with an external female connector portion.

3. The camera module for a vehicle according to claim 2, wherein the connection end circuit board has a plurality of electrical jacks; the terminal portion has a plurality of electrical pins; and the electrical pins of the terminal portion are correspondingly inserted into the electrical jacks.

4. The camera module for a vehicle according to claim 2, wherein the hollow sleeve has an inner hook structure that is formed at an inner side surface of the hollow sleeve; the male connector portion has a fastening bulge ring that is formed at a side surface of the male connector portion; and the male connector portion runs through the hollow sleeve, so that the fastening bulge ring of the male connector portion is fastened with the inner hook structure of the hollow sleeve.

5. The camera module for a vehicle according to claim 4, wherein the inner hook structure is surrounded by a plurality of projections that flush with each other.

6. The camera module for a vehicle according to claim 4, wherein the electrical connector is a Fakra electrical connector.

7. The camera module for a vehicle according to claim 1, wherein the flexible flat cable is connected to the connection end circuit board and the shooting end circuit board by means of welding, or the flexible flat cable is connected to the connection end circuit board and the shooting end circuit board by means of adhesion.

8. The camera module for a vehicle according to claim 1, wherein the hollow sleeve has an outer hook structure; the outer hook structure is formed by means of protruding outward from an outer side surface of the hollow sleeve; and the outer hook structure is used to be engaged with an external hook member.
